(19) United States
(12) Patent Application Publication
(10) Pub. No.: US 2005/0142052 A1
(43) Pub. Date: Jun. 30, 2005

(54) Method and apparatus to remove particulates from a gas stream

(76) Inventor: Eric B. Rosen, London (CA)

Correspondence Address: DARYL W SCHNURR;MILLER THOMSON LLP, PO BOX 578, SUITE 700, 22 FREDERICK STREET, KITCHENER, ON, N2G 4A2, CA

(21) Appl. No.: 10/743,752

(22) Filed: Dec. 24, 2003

(51) Int. Cl. B01D 47/06

(52) U.S. Cl. 423/215.5; 422/171; 422/172

(57) ABSTRACT

A method of removing particulates from a gas stream uses an emission control system having a condensor and a scrubber. Water is added upstream and removed in the condensor and scrubber along with particulates.

### BACKGROUND OF THE INVENTION

1. Field of the Invention

This invention relates to an emission control system to remove particulates from a gas stream and to a method of removing particulates from a gas stream. More particularly, the method includes adding water to the gas stream and subsequently removing water from the gas stream in a condenser, the water removed containing particulates.

2. Description of the Prior Art

Emission control systems are known. However, previous systems do not operate effectively to remove particulates from a gas stream, or, they are extremely expensive to operate or to construct, or they are inefficient and do not remove a sufficient proportion of the particulates.

Settling tanks have been used previously to separate particulates from a gas. Further, it is known to have a wet scrubber that uses water to separate particulates from a gas, but scrubbers either do not remove sufficient particulates or they are expensive and complex to manufacture or operate.

### SUMMARY OF THE INVENTION

It is an object of the present invention to provide a method of removing particulates from a gas stream by first adding water to the gas stream and subsequently removing water and particulates from the gas stream by condensing the gas stream. It is a further object of the present invention to provide an emission control system for removing particulates from a gas stream where water is added to the gas stream at a first location and subsequently removed in a condensor located at a second location downstream from the first location.

A method of removing particulates from a gas stream, the method comprising continuously adding water to the gas stream at a first location, continuously condensing the gas stream to remove water from the gas stream at a second location, the particulates being removed from the gas stream with the water, the second location being downstream from the first location.

An emission control system for use with a gas stream containing particulates uses a water supply connected to continuously add water to the gas stream at a fist location. A condensor is located at a second location downstream from the first location. The condensor is connected to operate at a lower temperature that the temperature of the gas stream. The condensor has a drain for water and particulates that are removed from the gas stream.

### BRIEF DESCRIPTION OF THE DRAWINGS

FIG. 1 is a block diagram of the emission control system of the present invention;

FIG. 2 is a schematic perspective view of one embodiment of the emission control system;

FIG. 3 is a perspective view of one embodiment of a scrubber used in the emission control system;

FIG. 4 is a schematic side view of a scrubber; and

FIG. 5 is a schematic perspective view of a further embodiment of the emission control system.

### DESCRIPTION OF A PREFERRED EMBODIMENT

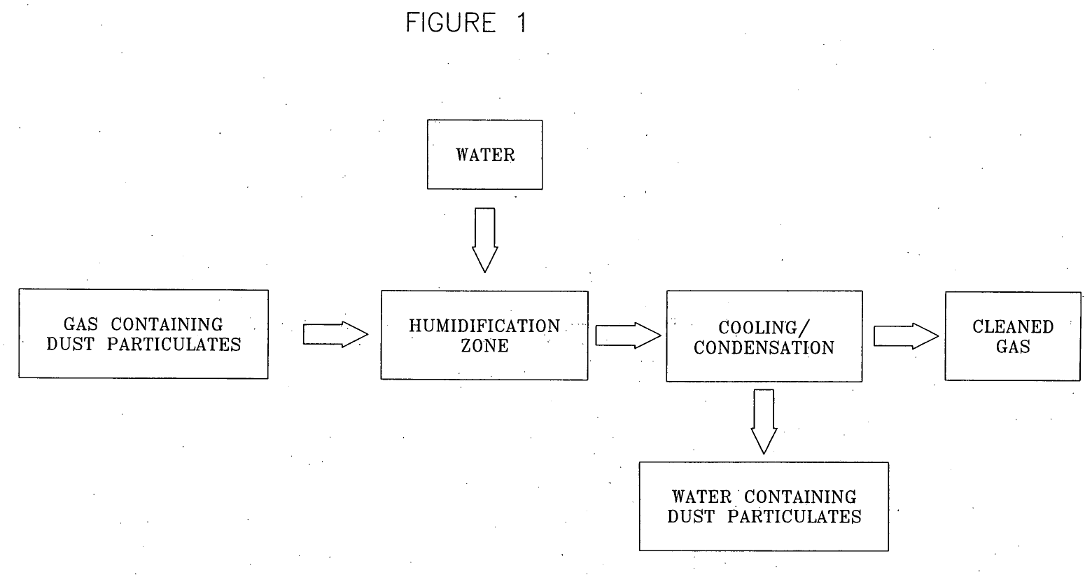

In FIG. 1, a gas stream containing particulates enters a humidification zone where water is added. Preferably, the water is added by using spray nozzles. The water is added to saturate the gas stream with water and, preferably, to add sufficient water to not only saturate the gas stream, but to have free water in the gas stream. Downstream from the humidification zone is a cooling/condensation area where the temperature of the gas stream is lowered. Preferably, a condensor is used to lower the temperature of the gas stream, but other devices and methods could be used in place of a condenser to lower the temperature of the gas stream. When the temperature of the gas stream is lowered, water is removed from the gas stream and the water removed contains particulates. Therefore, the particulates are substantially removed from the gas stream along with the water, resulting in a substantially clean gas stream. Preferably, substantially all of the water that is added in the humidification zone is removed in the cooling/condensation area. The greater the amount that the temperature of the gas stream is lowered, the more water that will be removed. Usually, the greater the amount that the temperature is lowered, the greater the expense will be to operate the cooling/condensation area. However, when ambient temperatures are low as they are during the winter in many geographic locations, the temperature of the gas stream can be lowered substantially using ambient air with minimal expense. For some gas streams, it will be desirable to lower the temperature by a sufficient amount to remove more water from the gas stream than the water that was added in the humidification zone. In some applications, it will be desirable to remove less water than the water that was added in the humidification zone. The method and device of the present invention allows a user to control the amount of water added as well as the amount of water removed. In most applications, it will be desirable to remove at least as much water as has been added to the gas stream.

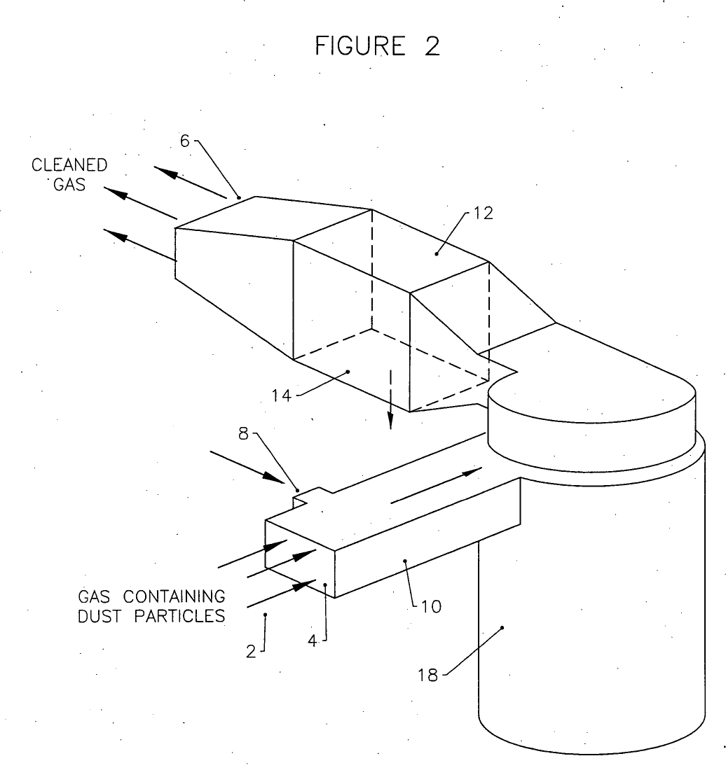

In FIG. 2, a gas stream 2 has an inlet 4 and an outlet 6. The gas stream at the inlet 4 contains particulates and the gas stream at the outlet 6 is clean gas. When the expression “clean gas” or similar expressions are used in this application, those expressions should not be interpreted as meaning that the clean gas is entirely free of particulates. The clean gas might still contain some particulates, but will contain fewer particulates than the gas stream contained prior to passing through the emission control system of the present invention. Preferably, the gas stream will contain substantially fewer particulates after passing through the emission control system of the present invention. Water is added to the gas stream at a water inlet 8 located at a first location 10.

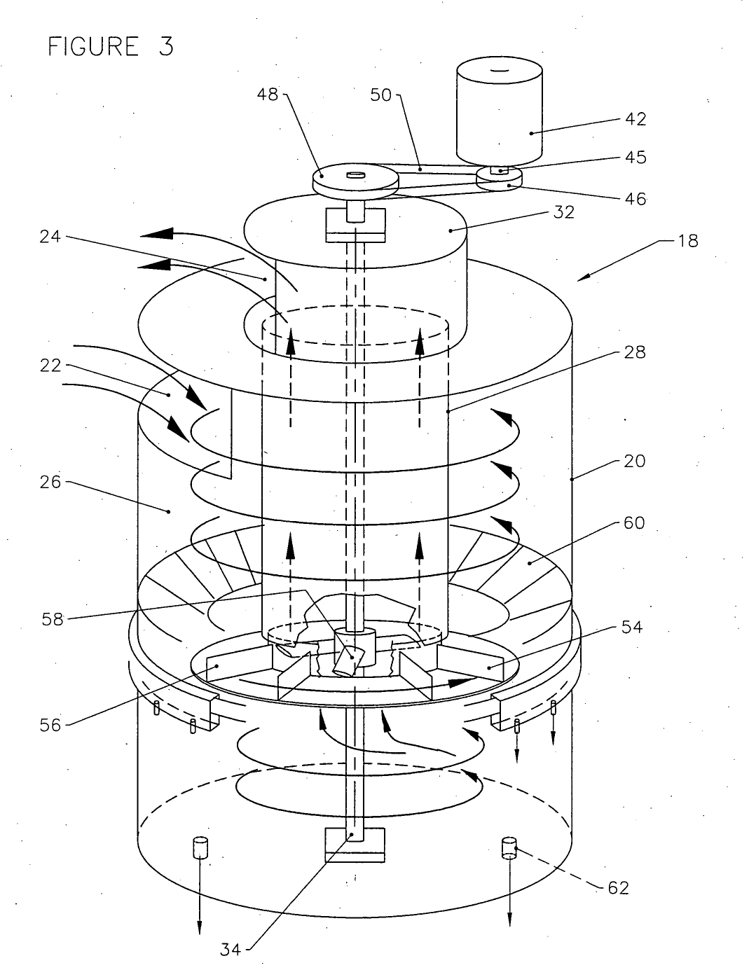

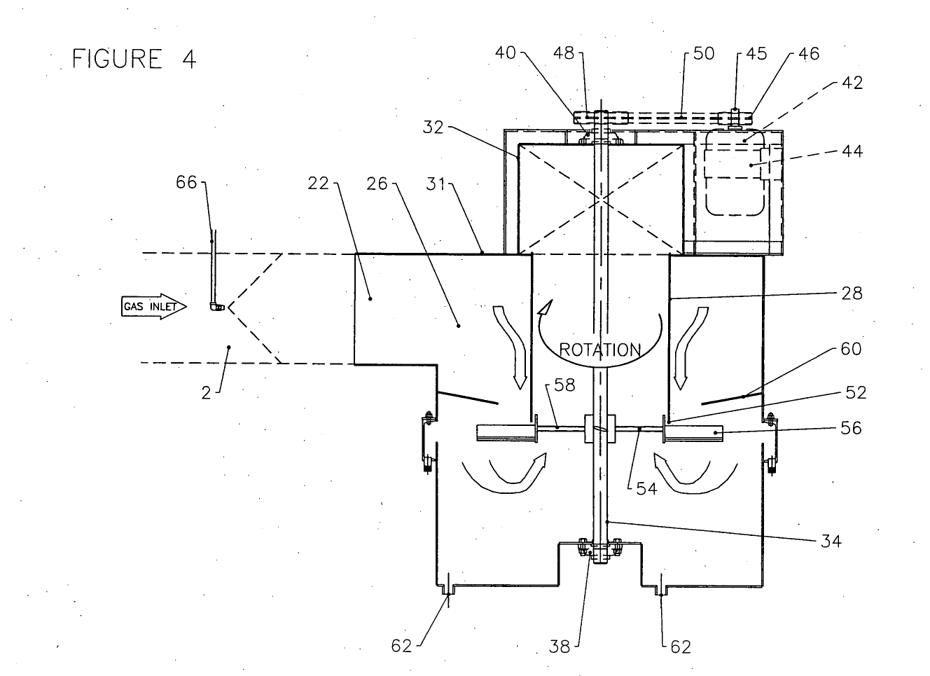

A condenser 12 is located at a second location 14. The second location is downstream from the first location. Preferably, spray nozzles are used at the water inlet to add water to the gas stream so that the water is dispersed throughout the gas stream. Preferably, a sufficient amount of water is added to the gas stream to saturate the gas stream with water. The condensor 12 has a drain 16 whereby water that is removed from the gas stream and particulates that are removed with the water can be drained from the condenser. Between the first location 10 and the second location 14, there is located a scrubber 18. The scrubber can be used to add more water to the gas stream and/or to remove some water from the gas stream along with some of the particulates. The scrubber 18 can be a conventional scrubber or it can be a scrubber as described in FIGS. 3 and 4. Preferably, the scrubber is a wet scrubber.

Referring to FIGS. 3 and 4 in greater detail, the scrubber 18 has housing 20 with an inlet 22 and an outlet 24. Within the housing 20, there is a passage 26, which extends in more than one direction to the outlet 24. A cylindrical section 28 of the passage 26 is concentrically mounted in an upper portion of the housing 20. On a top 31 of the housing 20, there is mounted a hood 32. A shaft 34 extends vertically through the housing 20 from the hood 32 to a bottom 36. The shaft 34 is rotatably mounted in bearings 38, 40. A motor 42 is mounted in a bracket 44. The motor has a shaft 45 with a pulley 46 mounted thereon. The shaft 34 that extends through the housing 20 has a pulley 48 mounted thereon. Preferably, the motor 42 is an electric motor (the electrical connections are not shown) and a belt 50 connects the pulleys 46, 48 so that the motor 42 can rotate the shaft 34. Beneath a lower edge 52 of the cylindrical section 28, there is a fan 54 mounted on the shaft 34. The fan 54 has blades 56 and inner vanes 58. The inlet 22 is located near the top 31 of the housing 20. The housing contains an annular baffle 60 that is located between the inlet 22 and the fan 54. Drains 62 are located in a base 64 of the housing 20. As is best shown in FIG. 4, a plurality of moisturizers 66 (only one of which is shown), which are preferably spray nozzles, is located just upstream from the inlet 22. The moisturizers 66 add a fine mist to the gas stream 2 just before the gas enters the inlet 22 of the scrubber 18. When the fan 54 is activated, gas containing particulates is drawn into the inlet 22 and is directed by the shape of the passage 26 and the annular baffle 60 downward and inward. Immediately after passing the baffle 60, the gas stream 2 strikes the outer blades 56 of the fan 54. The outer blades 56 are generally flat and lie in a vertical plane and the blades direct the gas outward and downward. Since the gas contains moisture, the blades 56 remove some of the moisture from the gas stream 2 and force it by centrifugal force against an inner wall of the housing 20 where it falls by gravity to the drains 62. The particulates affix themselves to water droplets in the mist. Therefore, as the moisture is removed, some of the particulate matter is also removed through the drains 62. After passing downward through the outer blades 56 of the fan 54, the gas stream is forced inward and upward by the inner vanes 58 of the fan 54 into an interior of the cylindrical section 28. The vanes 58 are angled to force the gas upward as the fan rotates. The abrupt change in direction causes the gas stream to lose more moisture and the gas stream moves upward through the hood 32 to the outlet 24. The gas stream 2 then moves on to the condensor (not shown in FIGS. 3 and 4) where the gas is further cleaned. The water that is added through the moisturizers 66 just upstream from the inlet 22 could be added to the gas stream within the scrubber 18. There are arrows located within the passage 26 to show the flow direction of the gas stream. The scrubber 18 shown in FIG. 3 is slightly different from the scrubber 18 shown in FIG. 4. the motor could be a direct drive with a gear box instead of having a shaft and pulley as shown.

The amount of water added to the gas stream is such that a wet environment is created with sufficient free water carried by the gas stream. In other words, the gas stream is preferably more than saturated with water.

The fan 54 of the scrubber 18 could have the inner vanes 58 removed and located in a separate fan, either within the scrubber or somewhere else in the gas stream between the inlet 4 and the outlet 6. With some gas streams, a fan to move the gas stream through the emission control system of the present invention will not be necessary. In other applications, a fan will be required to force the gas stream through the emission control system.

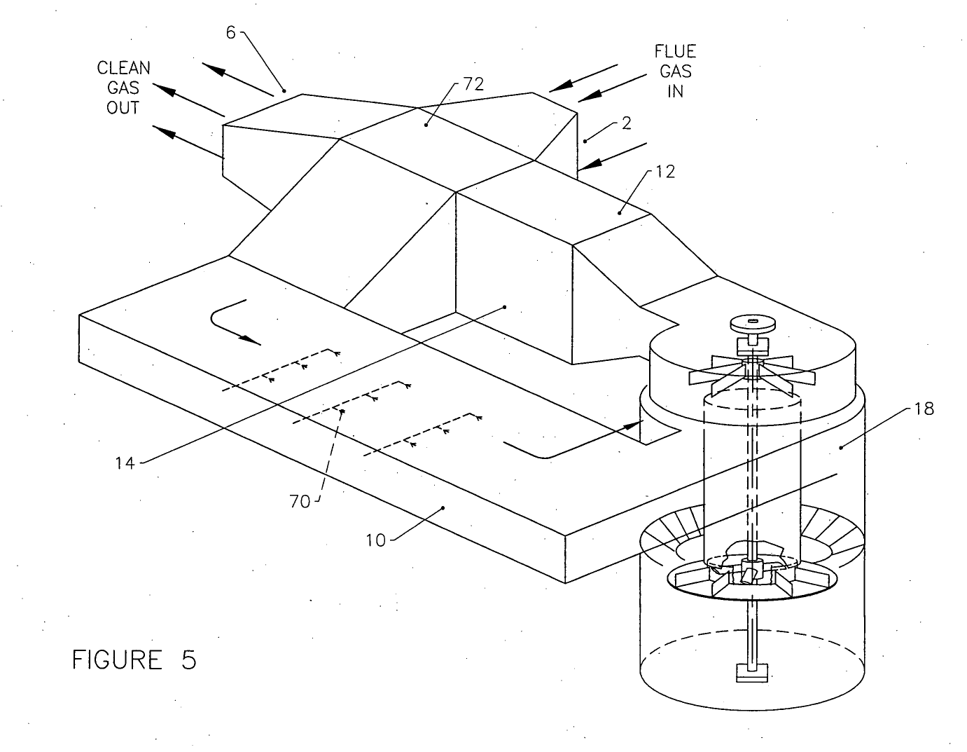

In FIG. 5, there is shown a perspective view of a further embodiment of an emission control system having a scrubber 18, which is described in detail in FIGS. 3 and 4. The same reference numerals are used in FIG. 5 to describe the components that are identical to the components of FIGS. 2, 3 and 4. Spray nozzles 70 are located before the scrubber 18. the detailed components of the scrubber 18 shown in FIG. 5 have not been numbered, but are identical to the components shown in FIGS. 3 and 4.

Preferably, all of the water that is drained from the emission control system is recovered and is collected in a container (not shown). The water is then connected to a pump and pumped back into the emission control system in the humidification zone. The circulation and re-use of the water reduces the water consumption significantly. By circulating and re-using the water, the concentration of suspended particles in the water will increase. The emission control system of the present invention can be operated continuously, or, intermittently, as required. The water is independently pumped from the container by a second pump to a filter (not shown) and then returned to the system. The recycled water is preferably filtered form time to time to keep the water reasonably clean.

The fan and rotor can be one component or separate components. The fan has blades to move the gas through the system. The rotor has vanes to remove water and particulates from the gas stream. the rotor is located in the scrubber. The fan can be located in the scrubber or elsewhere in the system. Preferably, the fan and rotor are one component.

The device of the present invention is efficient and cost effective to collect airborne dust particles from many sources of emissions. One source of these emissions is industrial boilers, including those that are burning waste wood and emit airborne ash particles (flyash) in the flue gas from gas stacks.

1. A method of removing particulates from a gas stream, said method comprising continuously adding water to said gas stream at a first location, continuously condensing said gas stream to remove water from said gas stream at a second location, said particulates being removed from said gas stream with said water, said second location being downstream from said first location.

2. A method of removing particulates from a gas stream, said method including the step of adding water to said gas stream using spray nozzles.

3. A method of removing particulates from a gas stream as claimed in claim 1, said method including the step of adding water to said gas stream until said gas stream is saturated with water.

4. A method of removing particulates from a gas stream including the step of adding water until said gas stream contains free water.

5. A method of removing particulates from a gas stream as claimed in claim 1, said method including the step of condensing said gas steam using a condensor located at said second location.

6. A method of removing particulates from a gas stream as claimed in claim 5 wherein there is a scrubber located between said first location and said condenser, said method comprising passing said gas stream through said scrubber before said condenser.

7. A method of removing particulates from a gas stream as claimed in claim 6, said method including the step of using said scrubber to remove some of said water and particulates.

8. A method of removing particulates from a gas stream as claimed in claim 6 wherein said scrubber is located at said first location, said method including the step of continuously adding water to said gas stream within said scrubber.

9. A method of removing particulates from a gas stream as claimed in claim 1 and there is a blower located in said gas stream to move said gas stream and a rotor to remove water from said gas stream, said method including the steps of using said blower to move said gas stream from said first location to said second location, and rotating said rotor to remove water and particulates from said gas stream.

10. A method of removing particulates from a gas stream as claimed in claim 6 wherein there is a fan located in said scrubber, said method including the step of operating said fan to move said gas stream from said first location to said second location.

11. A method of removing particulates from a gas stream as claimed in claim 5, said method including the step of operating said condenser to remove substantially all of said water added to said gas stream at said first location.

12. A method of removing particulates from a gas stream as claimed in claim 8 including the step of condensing said gas stream using a condensor located at said second location to remove substantially all of said water added to said gas stream prior to said condensor.

13. An emission control system for use with a gas stream containing particulates, said system comprising a water supply connected to continuously add water to said gas stream at a first location, a condenser located at a second location downstream from said first location, said condensor being connected to operate at a lower temperature than the temperature of said gas stream, said condensor having a drain for water and particulates that are removed from said gas stream.

14. An emission control system as claimed in claim 13 wherein there are spray nozzles located at said first location to continuously add water to said gas stream.

15. An emission control system as claimed in claim 13 wherein there is a scrubber located between said first location and said second location, said scrubber being connected to remove some of said water and particulates from said gas stream.

16. An emission control system as claimed in claim 13 wherein there is a scrubber located in said gas stream at said first location, said scrubber being connected to add water to said gas stream.

17. An emission control system as claimed in claim 13 wherein there is a blower located in said gas stream to move said gas stream between said first location and said second location.

18. An emission control system as claimed in claim 17 wherein there is a scrubber located in said gas stream at said first location and said blower is a fan located in said scrubber.

19. An emission control system as claimed in claim 15 wherein there is a fan located in said scrubber to move said gas stream between said first location and said second location.

20. An emission control system as claimed in claim 13 wherein there is a scrubber located in said gas stream between said first location and said second location, said scrubber being a wet scrubber.

21. An emission control system as claimed in claim 13 wherein said condenser is sized and operated to remove substantially all of said water that is added to said gas stream at said first location.
